(19) United States
(12) Patent Application Publication
(10) Pub. No.: US 2006/0292950 A1
(43) Pub. Date: Dec. 28, 2006

(54) Inflatable vehicle occupant protection device construction

(75) Inventor: Bruce R. Hill, Bloomfield Hills, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/165,068

(22) Filed: Jun. 23, 2005

(51) Int. Cl. B60R 21/16; B32B 5/22

(52) U.S. Cl. 442/76; 280/728.1

(57) ABSTRACT

An inflatable vehicle occupant protection device (14) is inflatable away from a roof (18) of a vehicle (12) to a position between a side structure (16) of the vehicle and a vehicle occupant. The protection device (14) includes overlying inboard and outboard panels (40 and 42) that help define an inflatable volume of the protection device. The outboard panel (42) is positioned between the inboard panel (40) and the side structure (16) when the protection device (14) is inflated. A first coating (50) is applied to the inboard panel (40) and a second coating (52) is applied to the outboard panel (42). The second coating (52) is different than the first coating (50) and has a puncture resistance greater than a puncture resistance of the first coating.

### FIELD OF THE INVENTION

The present invention relates to an inflatable vehicle occupant protection device for helping to protect an occupant of a vehicle.

### BACKGROUND OF THE INVENTION

It is known to inflate an inflatable vehicle occupant protection device to help protect a vehicle occupant in the event of a vehicle collision. Examples of inflatable vehicle occupant protection devices include driver and passenger side air bags, side air bags, inflatable curtains, inflatable seat belts, inflatable knee bolsters, and inflatable head liners.

Inflatable vehicle occupant protection devices may have a variety of constructions. For example, an inflatable vehicle occupant protection device may be constructed of overlying woven panels that are interconnected by means, such as stitching or ultrasonic welding, to form connections or seams that help define an inflatable volume of the protection device. As another example, an inflatable vehicle occupant protection device may have a one piece woven construction in which overlying panels are woven simultaneously. The panels are woven together to form connections or seams that help define an inflatable volume of the one piece woven protection device.

Inflatable vehicle occupant protection devices may also be sealed to help control the gas permeability of the protection device. This may be done to maintain pressurization of the inflatable vehicle occupant protection device for a desired duration. For example, a sealant may be applied to the inflatable vehicle occupant protection device via spray coating, knife coating, extrusion coating, or lamination.

### SUMMARY OF THE INVENTION

The present invention relates to an inflatable vehicle occupant protection device that is inflatable away from a roof of a vehicle to a position between a side structure of the vehicle and a vehicle occupant. The protection device includes overlying inboard and outboard panels that help define an inflatable volume of the protection device. The outboard panel is positioned between the inboard panel and the side structure when the protection device is inflated. A first coating is applied to the inboard panel and a second coating is applied to the outboard panel. The second coating is different than the first coating and has a puncture resistance greater than a puncture resistance of the first coating.

The present invention also relates to an apparatus for helping to protect an occupant of a vehicle having a side structure. The apparatus includes an inflatable vehicle occupant protection device inflatable to a position between the side structure of the vehicle and a vehicle occupant. The apparatus also includes an inflation fluid source that is actuatable to provide inflation fluid for inflating the protection device. The protection device includes overlying inboard and outboard panels interconnected to define an inflatable volume. A first coating is applied to the inboard panel and a second coating applied to the outboard panel. The second coating is different than the first coating and has a puncture resistance greater than a puncture resistance of the first coating.

The present invention further relates to a one piece woven inflatable curtain comprising at least one woven single layer portion and at least one woven multilayer portion that define at least one inflatable chamber. At least one layer of the multilayer portions being woven in a non-plain weave pattern.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect an occupant of a vehicle illustrating stored and deployed positions of the protection device, according to the present invention;

FIG. 2 is a sectional view of the apparatus taken generally along line 2-2 in FIG. 1;

FIGS. 3-5 are enlarged sectional views of a portion of the apparatus, according to alternate embodiments of the present invention;

FIG. 6A is a sectional view of the apparatus taken generally along line 6A-6A in FIG. 2; and

FIGS. 6B and 6C are sectional views of the apparatus taken generally along lines 6B-6B and 6C-6C, respectively, in FIG. 6A.

### DETAILED DESCRIPTION OF THE INVENTION

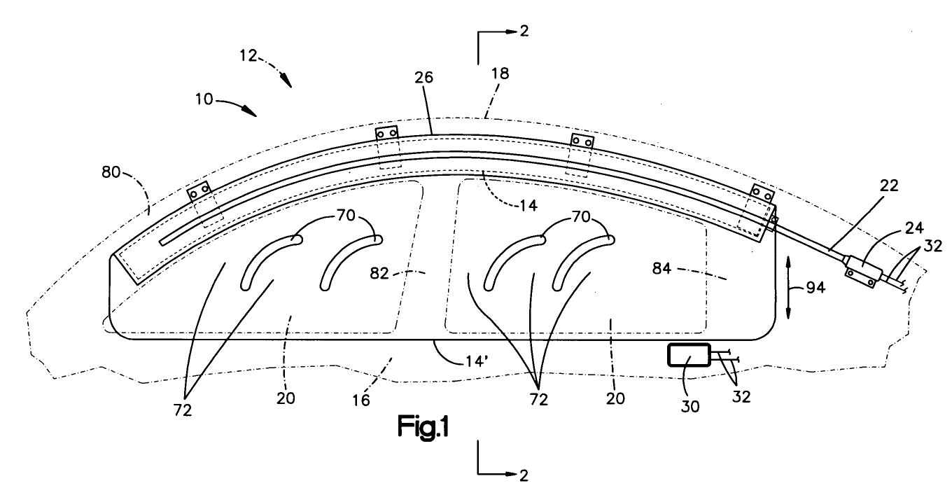

As representative of the present invention, an apparatus 10 helps to protect an occupant of a vehicle 12. As shown in FIG. 1, the apparatus 10 includes an inflatable vehicle occupant protection device in the form of an inflatable curtain 14 that is mounted adjacent the side structure 16 of the vehicle 12 and a roof 18 of the vehicle. The roof 18 may be either a standard roof that is fixed in place or a convertible roof that can be moved or removed. The side structure 16 of the vehicle 12 includes side windows 20. An inflator 24 is connected in fluid communication with the inflatable curtain 14 through a fill tube 22. The inflatable curtain 14 is inflatable from a deflated and stored position indicated at 14 to an inflated and deployed position indicated at 14′.

The fill tube 22 has a portion, disposed in the inflatable curtain 14, with a plurality of openings (not shown) that provide fluid communication between the fill tube 22 and the inflatable curtain 14. The fill tube 22 could be omitted, in which case the inflator 24 could direct inflation fluid into the inflatable curtain 14 directly or via a manifold. The inflator 24 is actuatable to provide inflation fluid for inflating the inflatable curtain 14 and maintaining the curtain in an inflated condition for a desired duration, such as at least two seconds, at least five seconds, or longer.

The inflator 24 may contain a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 22 could be of any suitable type or construction for supplying a medium for inflating the inflatable curtain 14 and maintaining the curtain in an inflated condition for a desired duration.

The apparatus 10 includes a housing 26 that stores the inflatable curtain 14 in a deflated condition. The fill tube 22, the deflated inflatable curtain 14, and housing 26 have an elongated configuration and extend along the vehicle roof 18 and along the side structure 16 of the vehicle 12 above the side windows 20. The housing 26 may have a variety of constructions. For example, the housing 26 may comprise a fabric sheath or a plastic housing.

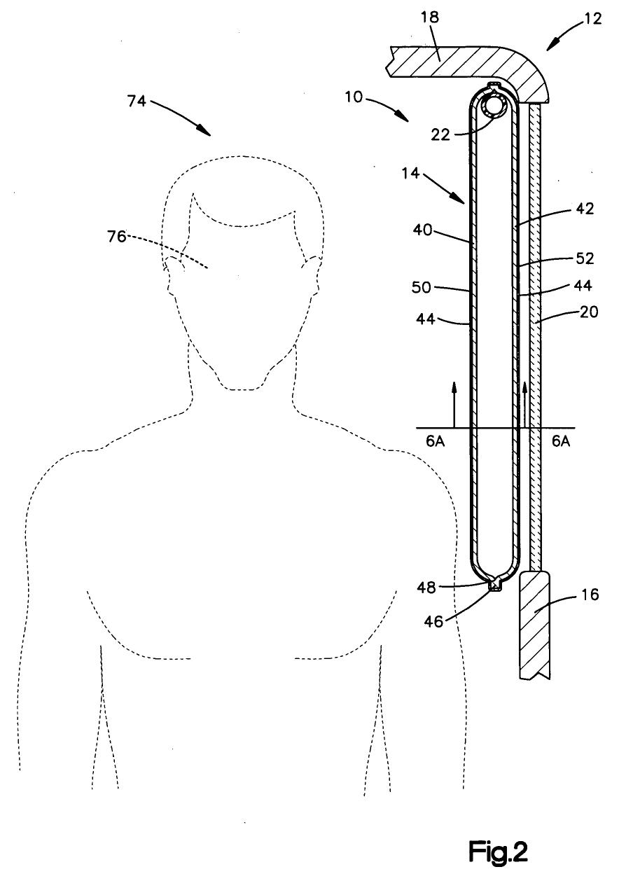

The inflatable curtain 14 may have any suitable construction. For example, as shown in FIG. 2, the inflatable curtain 14 may include panels 40 and 42 of material that are arranged in an overlying manner. Portions of the panels 40 and 42 are secured together. For example, the panels 40 and 42 may be secured together along at least a portion of a perimeter 48 of the inflatable curtain 14 to form a perimeter connection 46 of the curtain. The perimeter connection 46 helps define an inflatable volume of the inflatable curtain 14. The perimeter connection 46 may be formed in a variety of manners, such as by weaving the panels 40 and 42 as a single piece of material in a one piece woven construction, stitching the panels together, or interconnecting the panels by ultrasonic welding, heat bonding, or adhesives.

The inflatable curtain 14 may also include interior connections 70 (FIG. 1) in which the overlying panels 40 and 42 are secured together within the perimeter 48 of the curtain. The interior connections 70 form non-inflatable portions of the inflatable curtain 14 within the perimeter 48 of the curtain. The interior connections 70 also help define inflatable chambers 72 of the inflatable curtain 14. The configuration of the interior connections 70, and thus the chambers 72, may vary depending on a variety of factors, such as the architecture of the vehicle 12, the position of the inflatable curtain 14 in the vehicle, and the desired extent or coverage of the curtain.

The panels 40 and 42 are woven from a material, such as nylon yarn or polyester yarn. A sealant 44 may be applied to outer surfaces of the panels 40 and 42 to give the inflatable curtain 14 a desired degree of gas permeability. For example, the sealant 44 may provide the inflatable curtain 14 with a substantially gas impermeable construction.

The vehicle 12 includes a sensor mechanism 30 (shown schematically in FIG. 1) for sensing a side impact to the vehicle 12 and/or a rollover of the vehicle 12. The sensor mechanism 30 actuates the inflator 24 in response to sensing a side impact or a vehicle rollover. In the event of a rollover of the vehicle 12 or a side impact to the vehicle for which inflation of the inflatable curtain 14 is desired, the sensor mechanism 30 provides an electrical signal over lead wires 32 to the inflator 24. The electrical signal causes the inflator 24 to be actuated in a known manner. The inflator 24 discharges fluid under pressure into the fill tube 22. The fill tube 22 directs the fluid into the inflatable curtain 14.

The inflatable curtain 14 inflates under the pressure of the inflation fluid from the inflator 24. The housing 26 opens and the inflatable curtain 14 inflates and unrolls in a direction away from the roof 18 in a downward direction as shown in the drawings and in a downward direction with respect to the direction of forward travel of the vehicle 12 into the inflated and deployed condition illustrated at 14′.

The inflatable curtain 14, when inflated, extends along the side structure 16 of the vehicle 12 and is positioned between the side structure and any occupant of the vehicle. The inflatable curtain 14 extends between an A pillar 80 and a C pillar 84 of the vehicle 12 and overlies at least a portion of the A pillar, C pillar, and a B pillar 82 of the vehicle.

It will be recognized by those skilled in the art that the inflatable curtain may have alternative configurations. For example, in the illustrated embodiment, the inflatable curtain 14 extends between the A pillar 80 and the C pillar 84 of the vehicle 12. The inflatable curtain 14 could, however, extend between the A pillar 80 and the B pillar 82 only or between the B pillar and the C pillar 84 only. Also, in a vehicle (not shown) having a D-pillar, the inflatable curtain 14 could extend between the A pillar and the D pillar. As another example, the configuration of the perimeter connection 46, connections 70, or both could differ from that shown in FIG. 1. In this instance, the inflatable chambers 72 of the curtain would differ from that shown in FIG. 1.

As shown in FIG. 2, the panel 40 forms an inboard panel presented generally toward the occupant compartment 74 of the vehicle 12. The panel 42 forms an outboard panel that faces the vehicle side structure 16 and is positioned adjacent the side structure. When the inflatable curtain 14 is in the inflated and deployed position, the inboard panel 40 is positioned between the outboard panel 42 and any occupants 76 of the vehicle 12. Also, when the inflatable curtain 14 is in the inflated and deployed position, the outboard panel 42 is positioned between the inboard panel 40 and the vehicle side structure 16. The panels 40 and 42 help define inboard an outboard walls, respectively, of the inflatable volume.

During a side impact or a vehicle rollover, the outboard panel 42 of the inflatable curtain 14 may be susceptible to puncture, abrasion, or other physical damage. For example, in the event of a side impact, the outboard panel 42 may come into contact with broken glass or sheet metal from the vehicle 12 or another vehicle involved in the side impact. In the event of a rollover, the outboard panel 42 may come into contact with broken glass or sheet metal from the vehicle 12, or the roadway upon which the vehicle is traveling. Such punctures, abrasions or other physical damage to the outboard panel 42 may cause the inflatable curtain 14 to deflate, which may negatively affect the ability of the inflatable curtain to help protect an occupant of the vehicle 12. Also, objects that penetrate the inflatable curtain 14 could pass through the curtain and contact an occupant of the vehicle.

According to one aspect of the present invention, the sealant 44 applied to the inboard panel 40 is different than the sealant applied to the outboard panel 42. The sealant, indicated at 52, applied on the outboard panel 42 is selected to have a puncture resistance greater than the puncture resistance of the sealant, indicated at 50, applied to the inboard panel 40. Both sealants 50 and 52 help provide a desired degree of gas permeability of the panels 40 and 42. For example, both sealants 50 and 52 may be substantially gas impermeable.

The sealants 50 and 52 may comprise one or more coating materials that are applied to the panels 40 and 42 by known means, such as spray coating, knife coating or extrusion coating. Alternatively, the sealants 50 and 52 may comprise a laminate applied to the panels 40 and 42 by known means, such as through heat and pressure, e.g., heat rolling. As a further alternative, the sealants 50 and 52 may comprise a combination of the above. For example, the sealant 50 applied to the inboard panel 40 may comprise a coating and the sealant 52 applied to the outboard panel 42 may comprise a laminate.

To illustrate how the puncture resistance of the panels 40 and 42 is affected by the sealants 50 and 52 applied to the panels, a load test was performed on fabric samples coated or laminated with different materials. The fabric was woven with nylon 6-6 yarn. The load test was performed by securing the fabric sample under tension while a simulated glass shard was advanced toward the sealant side of the sample at a predetermined rate. For this particular load test, the advance rate was 508 mm/min. The simulated glass shard was advanced until the shard punctured the fabric sample. The peak load (lbs. force) was recorded as being indicative of the affect the particular sealant has on puncture resistance. The results of the tests is shown below in Table 1:

TABLE 1

| | | | | Mean |
|---|---|---|---|---|
| Filament | | | # of | Maximum |
| Size* | Sealant | Weight | Tests | Load (lbf.) |
| 235 DTEX | Silicone | 30 g/m² | 4 | 67.10 |
| 350 DTEX | Uncoated | N/A | 4 | 103.67 |
| 350 DTEX | Polycarbonate | 18 g/m² | 4 | 117.60 |
| | Polyurethane | | | |
| | (PCPU) (base layer) | | | |
| | Polyether | 12 g/m² | | |
| | Polyurethane (PEPU) | | | |
| | (top layer) | | | |
| 350 DTEX | Polycarbonate | 38 g/m² | 4 | 107.57 |
| | Polyurethane | | | |
| | (PCPU) (base layer) | | | |
| | Polyether | 12 g/m² | | |
| | Polyurethane (PEPU) | | | |
| | (top layer) | | | |
| 350 DTEX | Silicone | 25 g/m² | 5 | 75.61 |
| 350 DTEX | Polyether | 28 g/m² | 4 | 110.65 |
| | Urethane (PEU) | | | |
| 350 DTEX | Urethane | 26 g/m² | 4 | 99.70 |
| | Polycarbonate (UPC) | | | |
| 350 DTEX | Rhodia ® Silicone | 34 g/m² | 4 | 87.10 |
| 350 DTEX | Dow ® Silicone | 34 g/m² | 4 | 80.42 |
| 350 DTEX | Wacker ® Silicone | 33 g/m² | 4 | 78.73 |
| 350 DTEX | Urethane Laminate | 70 g/m² | 4 | 119.13 |
| 470 DTEX | Milliken ® Silicone | 70 g/m² | 4 | 97.68 |

*Fabric is plain woven Nylon 6,6 yarn.

Based on the test results shown in Table 1, it be appreciated that the puncture resistance of the 40 and 42 can vary, depending on the type of sealant 50 and 52, respectively, applied to the panels. For example, on the 350 DTEX fabric, application of the silicone coatings from various manufacturers provided similar results with maximum loads in the range of 75.61 to 87.10 pounds force (lbf.). The variance in results for the silicone coatings from the different manufacturers can be attributed differences in the specific composition of the silicone coating of each manufacturer.

Silicone proved to be a good choice for the sealant 50 applied to the inboard panel 40. This is because silicone provides good performance in terms of gas impermeability and is cost effective. Also, the use of silicone as the sealant 50 on the inboard panel 40 may help provide the inflatable curtain 14 with improved packaging properties. This is because silicone is a generally low hardness, soft material. The silicone coating is thus conducive to rolling, folding, or otherwise placing the inflatable curtain 14 in the stored position. Materials having a hardness that is higher than that of silicone, such as urethane coatings and laminates, are less conducive to rolling, folding, or otherwise placing the inflatable curtain 14 in the stored position.

Table 1 also shows test results for two different two-layer coatings. One of the two-layer coatings is about 30 g/m² in total weight and includes a polycarbonate polyurethane (PCPU) base layer having a weight of about 18 g/m² and a polyether polyurethane (PEPU) top layer having a weight of about 12 g/m^{2.} The other two-layer coating is about 50 g/m² in total weight and includes a PCPU base layer having a weight of about 38 g/m² and a PEPU top layer having a weight of about 12 g/m^{2.} As shown in Table 1, the 30 g/m² total weight two-layer PCPU/PEPU coating exhibits a maximum load rating of 117.60 lbf. and the 50 g/m² total weight two-layer PCPU/PEPU coating exhibits a maximum load rating of 107.57 lbf. The two-layer PCPU/PEPU coatings thus provide improved puncture resistance over the silicone coatings.

Table 1 also shows test results for a urethane polycarbonate (UPC) coating applied in a single layer with a weight of about 26 g/m^{2.} As shown in Table 1, the UPC coating exhibits a maximum load rating of 99.70 lbf. The UPC coating thus provides improved puncture resistance over the silicone coatings.

Table 1 also shows test results for a polyether urethane (PEU) coating applied in a single layer with a weight of about 28 g/m^{2.} As shown in Table 1, the UPC coating exhibits a maximum load rating of 110.65 lbf. The UPC coating thus provides improved puncture resistance over the silicone coatings.

Table 1 further shows test results for a urethane laminate applied with a weight of about 70 g/m^{2.} The laminate may be applied in a process in which a urethane primer coat is applied to the fabric with a weight of about 25-35 g/m² via, for example, a spray coating or knife coating process. The primer coat is then cured/dried. A urethane film is placed over the primer coat and bonded to the primer coat via the application of heat and pressure, such as by a heated roller. As shown in Table 1, the urethane laminate exhibits a maximum load rating of 119.13 lbf. The urethane laminate thus provides improved puncture resistance over the silicone coatings.

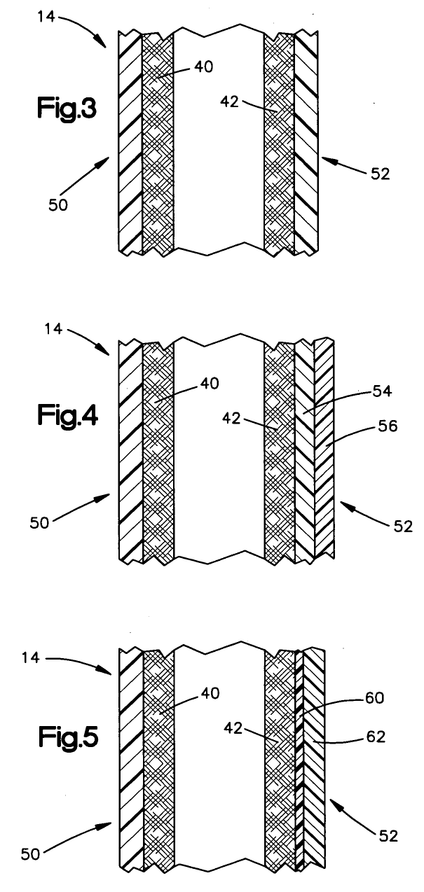

FIGS. 3-6C illustrate different combinations of sealants 50 and 52 applied to the panels 40 and 42, respectively, according to different embodiments of the present invention. In an embodiment of the present 10 invention shown in FIG. 3, the sealants 50 and 52 are coatings applied to the inboard and outboard panels 40 and 42, respectively, in single layers. For the embodiment of FIG. 3, the sealants 50 and 52 applied to the panels 40 and 42 may be any of the combinations set forth below in the examples of Table 2:

TABLE 2

| Inboard Panel* | | | Outboard Panel* | |
|---|---|---|---|---|
| Sealant | Weight | Example | Sealant | Weight |
| Silicone | 25 g/m² | 1 | Urethane | 28 g/m² |
| | | | Polycarbonate | |
| | | 2 | Polyether | 26 g/m² |
| | | | Urethane | |
| Rhodia ® Silicone | 34 g/m² | 3 | Urethane | 28 g/m² |
| | | | Polycarbonate | |
| | | 4 | Polyether | 26 g/m² |
| | | | Urethane | |
| Dow ® Silicone | 34 g/m² | 5 | Urethane | 28 g/m² |
| | | | Polycarbonate | |
| | | 6 | Polyether | 26 g/m² |
| | | | Urethane | |
| Wacker ® Silicone | 33 g/m² | 7 | Urethane | 28 g/m² |
| | | | Polycarbonate | |
| | | 8 | Polyether | 26 g/m² |
| | | | Urethane | |

*Fabric is plain woven Nylon 6,6 yarn.

As shown Table 2, in the embodiment of FIG. 3, the sealant 50 applied to the inboard panel 40 comprises a silicone coating. The silicone coating used for the sealant 50 can be any of the silicone compounds whose puncture test results are set forth in Table 1. Therefore, in the embodiment of FIG. 3, the inboard panel 40 may have a desired gas permeability (e.g., substantially gas tight) and may also exhibit good packaging properties.

Also, as shown Table 2, in the embodiment of FIG. 3, the sealant 52 applied to the outboard panel 42 comprises either a urethane polycarbonate coating or a polyether urethane coating. As shown in the puncture test results of Table 1, the polyether urethane coating had the best performance in terms of maximum load (110.65 lbf.) followed by the urethane polycarbonate coating (99.70 lbf.). Therefore, in the embodiment of FIG. 3, the outboard panel 42 may have a desired gas permeability (e.g., substantially gas tight) and may also exhibit improved puncture resistance.

In an embodiment of the present invention shown in FIG. 4, the sealant 50 is applied to the inboard panel 40 in a single layer and the sealant 52 is applied to the outboard panel in two layers. As shown in FIG. 4, the sealant 52 includes a base layer 54 and a top layer 56. For the embodiment of FIG. 4, the sealants 50 and 52 applied to the panels 40 and 42 may be any of the combinations set forth below in the examples of Table 3:

TABLE 3

| Inboard Panel* | | | Outboard Panel* | |
|---|---|---|---|---|
| Sealant | Weight | Example | Sealant | Weight |
| Silicone | 25 g/m² | 1 | PCPU (base) | 18 g/m² |
| | | | PEPU (top) | 12 g/m² |
| | | 2 | PCPU (base) | 38 g/m² |
| | | | PEPU (top) | 12 g/m² |
| Rhodia ® Silicone | 34 g/m² | 3 | PCPU (base) | 18 g/m² |
| | | | PEPU (top) | 12 g/m² |
| | | 4 | PCPU (base) | 38 g/m² |
| | | | PEPU (top) | 12 g/m² |
| Dow ® Silicone | 34 g/m² | 5 | PCPU (base) | 18 g/m² |
| | | | PEPU (top) | 12 g/m² |
| | | 6 | PCPU (base) | 38 g/m² |
| | | | PEPU (top) | 12 g/m² |
| Wacker ® Silicone | 33 g/m² | 7 | PCPU (base) | 18 g/m² |
| | | | PEPU (top) | 12 g/m² |
| | | 8 | PCPU (base) | 38 g/m² |
| | | | PEPU (top) | 12 g/m² |

*Fabric is plain woven Nylon 6,6 yarn.

As shown Table 3, in the embodiment of FIG. 4, the sealant 50 applied to the inboard panel 40 comprises a silicone coating. The silicone coating used for the sealant 50 can be any of the silicone compounds whose puncture test results are set forth in Table 1. Therefore, in the embodiment of FIG. 4, the inboard panel 40 may have a desired gas permeability (e.g., substantially gas tight) and may also exhibit good packaging properties.

Also, as shown Table 3, in the embodiment of FIG. 4, the sealant 52 applied to the outboard panel 42 may comprise either of the PCPU/PEPU two-layer coatings set forth in Table 1, i.e., the 30 g/m² total weight two-layer coating or the 50 g/m² total weight two-layer coating. As shown in the puncture test results of Table 1, the 30 g/m² total weight two-layer PCPU/PEPU coating had the best performance in terms of maximum load (117.60 lbf.) followed by the 50 g/m² total weight two-layer PCPU/PEPU coating (107.57 lbf.). Therefore, in the embodiment of FIG. 4, the outboard panel 42 may have a desired gas permeability (e.g., substantially gas tight) and may also exhibit improved puncture resistance.

In an embodiment of the present invention shown in FIG. 5, the sealant 50 applied to the inboard panel 40 comprises a single layer coating and the sealant 52 applied to the outboard panel comprises a laminate. For the embodiment of FIG. 5, the sealants 50 and 52 applied to the panels 40 and 42 may be any of the combinations set forth below in the examples of Table 4 :

TABLE 4

| Inboard Panel* | | | Outboard Panel* | |
|---|---|---|---|---|
| Sealant | Weight | Example | Sealant | Weight |
| Silicone | 25 g/m² | 1 | Urethane | 70 g/m² |
| | | | Laminate | |
| Rhodia ® Silicone | 34 g/m² | 2 | Urethane | 70 g/m² |
| | | | Laminate | |
| Dow ® Silicone | 34 g/m² | 3 | Urethane | 70 g/m² |
| | | | Laminate | |
| Wacker ® Silicone | 33 g/m² | 4 | Urethane | 70 g/m² |
| | | | Laminate | |

*Fabric is plain woven Nylon 6,6 yarn.

As shown Table 4, in the embodiment of FIG. 5, the sealant 50 applied to the inboard panel 40 comprises a silicone coating. The silicone coating used for the sealant 50 can be any of the silicone compounds whose puncture test results are set forth in Table 1. Therefore, in the embodiment of FIG. 5, the inboard panel 40 may have a desired gas permeability (e.g., substantially gas tight) and may also exhibit good packaging properties.

Also, as shown Table 4, in the embodiment of FIG. 5, the sealant 52 applied to the outboard panel 42 is a 70 g/m² urethane laminate. As shown in the puncture test results of Table 1, the urethane laminate had the best performance in terms of maximum load (119.13 lbf.). Therefore, in the embodiment of FIG. 5, the outboard panel 42 may have a desired gas permeability (e.g., substantially gas tight) and may also exhibit improved puncture resistance.

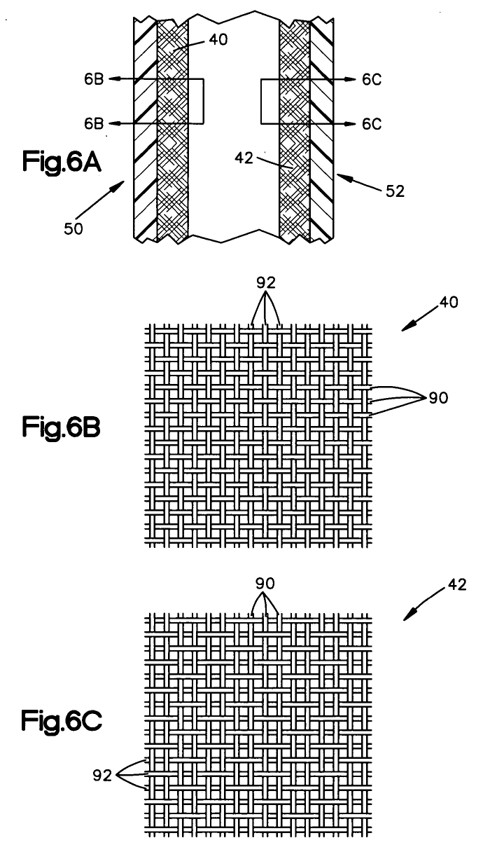

According to another aspect of the invention, in embodiment shown in FIGS. 6A-6C, the panels 40 and 42 are woven in different weave patterns. More particularly, the inboard panel 40 is woven in a plain weave and the outboard panel 42 is woven in a non-plain weave.

Referring to FIGS. 6B and 6C, the panels 40 and 42 include a plurality of warp yarns, or ends, indicated at 90 and a plurality of fill yarns, also known as weft yarns, or picks, indicated at 92. The warp yarns 90 and the fill yarns 92 are oriented perpendicular to each other. The warp yarns 90 and fill yarns 92 are thus woven around each other in an alternating “up and down” fashion. Depending on the particular weave pattern, the one or more fill yarns 92 are woven alternately over and under one or more warp yarns 90.

Referring to FIG. 6B, the inboard panel 40 is woven in a one-by-one (1×1) weave pattern referred to in the art as a “plain weave” pattern. In this plain weave pattern of the inboard panel 40, each warp yarn 90 is woven around each fill yarn 92 in an alternating fashion. Also, in the plain weave pattern, each fill yarn 92 is woven around each warp yarn 90 in an alternating fashion. The warp yarns 90 and fill yarns 92 are thus woven around each other at every intersection.

Referring to FIG. 6C, the outboard panel 42 is woven in a non-plain one-by-two (1×2) weave pattern. The outboard panel 42 could, however, have an alternative non-plain weave pattern. In the warp direction of the 1×2 weave pattern of the outboard panel 42, each warp yarn 90 is woven around single fill yarns 92 in an alternating fashion. In the 1×2 weave pattern, each warp yarn 90 is woven around groups of two fill yarns 92 in an alternating fashion.

In a one piece woven construction of the inflatable curtain of FIGS. 6A-6C, the inboard and outboard panels 40 and 42 comprise multilayer portions of the curtain and the perimeter connection 46 and connections 70 comprise single layers or seams of the curtain. The single layer seams 46 and 70 and the multilayer panels 40 and 42 define the inflatable chambers 72 of the curtain.

In the one piece woven construction, one or both of the inboard and outboard panels 40 and 42 may be woven in the non-plain weave pattern described above. The outboard panel 42 may have portions woven in a plain weave pattern in areas adjacent single layer portions of the curtain, e.g., adjacent the perimeter connection 46 (FIG. 2) and the connections 70 (FIG. 1). For example, the outboard panel 42 may be woven in a plain weave pattern within five (5) millimeters of the single layer portions of the curtain. This may help improve the permeability of the curtain in high stress areas of the curtain.

The sealant 50 applied to the inboard panel and the sealant 52 applied to the outboard panel 42 may be any sealant, such as those set forth in Table 1. In the embodiment of FIG. 6A, the sealants 50 and 52 comprise single layer coatings. To illustrate how the different weave patterns of the panels 40 and 42 affect the puncture resistance of the panels, Table 5 sets forth puncture resistance test results for coated fabrics having the woven construction of the panels 40 and 42 of FIGS. 6A-6C.

The fabrics for which test results are shown in Table 5 were constructed with 470 DTEX nylon 6,6 yarn and were coated with silicone having a weight of 25 g/m². One tested fabric was woven in a 1×1 plain weave pattern and therefore represents the inboard panel 40. The other tested fabric was woven in a 1×2 non-plain weave pattern and therefore represents the outboard panel 42. The results of the tests are set forth below in Table 5:

TABLE 5

| Filament | | # of | Mean Maximum |
|---|---|---|---|
| Size* | Fabric/Sealant | Tests | Load (lbf.) |
| 470 DTEX | 1 × 1 Plain Weave | 4 | 98.92 |
| | with 25 g/m² | | |
| | silicone coating | | |
| 470 DTEX | 1 × 2 Basket Weave | 4 | 179.09 |
| | with 25 g/m² | | |
| | silicone coating | | |

*Fabric is plain woven Nylon 6,6 yarn.

As shown Table 5, in the embodiment of FIGS. 6A-6C, the incorporation of the 1×2 weave pattern provides a significant improvement in puncture resistance for the outboard panel 42. This can be attributed, at least in part, to the fact that the 1×2 weave pattern permits a greater degree of shifting among the warp yarns 90 and fill yarns 92 of the outboard panel 42. This is because the fill yarns 92 of the 1×2 weave pattern are not interlaced as often as the fill yarns of the 1×1 plain weave pattern. In the 1×2 weave pattern, the yarns 90 and 92 are permitted to move relative to each other in response to a puncturing object, which helps the yarns resist breaking, tearing, or otherwise failing.

Additionally, the silicone coating used as the sealants 50 and 52 for both panels 40 and 42 may provide a desired gas permeability (e.g., substantially gas tight) and may also exhibit good packaging properties, as described above. Furthermore, since the yarns 90 and 92 are woven more loosely in the 1×2 pattern, the fabric will tend to have a lower stiffness, which may facilitate rolling, folding, or otherwise placing the inflatable curtain 14 in the stored position. The inflatable curtain having the construction of FIGS. 6A-6C may thus have improved packaging properties.

From the above description of the invention, those skilled in the art will perceive improvements, changes and modifications. Such improvements, changes and modifications within the skill of the art are intended to be covered by the appended claims.

Having described the invention, the following is: claimed:

1. An inflatable vehicle occupant protection device inflatable between a side structure of the vehicle and a vehicle occupant, said protection device comprising:
overlying inboard and outboard panels that help define an inflatable volume of the protection device, said outboard panel being positioned between said inboard panel and the side structure when said protection device is in the deployed position;
a first coating applied to said inboard panel; and
a second coating applied to said outboard panel, said second coating being different than said first coating and having a puncture resistance greater than a puncture resistance of said first coating.

2. The inflatable vehicle occupant protection device recited in claim 1, wherein said first and second coatings have associated packaging properties, the packaging properties of said first coating providing for folding said protection device to form a small package size of said protection device more readily than said packaging properties of said second coating.

3. The inflatable vehicle occupant protection device recited in claim 1, wherein said first and second coatings are substantially gas impermeable.

4. The inflatable vehicle occupant protection device recited in claim 1, wherein said first and second coatings are disposed on an outer surface of said protection device.

5. The inflatable vehicle occupant protection device recited in claim 1, wherein said protection device comprises an inflatable curtain.

6. The inflatable vehicle occupant protection device recited in claim 1, wherein said inboard and outboard panels have a woven construction, said interconnected portions comprising portions of said inboard and outboard panels woven together.

7. The inflatable vehicle occupant protection device recited in claim 1, wherein said inboard panel defines at least one inboard wall of said inflatable volume and said outboard panel defines at least one outboard wall of said inflatable volume, said inboard and outboard panels having woven constructions in which portions of said at least one outboard wall are woven in a weave pattern that is more loose than a weave pattern with which opposing portions of said at least one inboard wall are woven.

8. The inflatable vehicle occupant protection device recited in claim 7, wherein said at least one inboard wall is woven with a plain weave pattern and opposing portions of said at least one outboard wall are woven in a non-plain weave pattern.

9. The inflatable vehicle occupant protection device recited in claim 7, wherein said at least one inboard wall is woven with a 1×1 weave pattern and opposing portions of said at least one outboard wall are woven in a 1×2 weave pattern.

10. The inflatable vehicle occupant protection device recited in claim 1, wherein said first coating comprises a silicone coating.

11. The inflatable vehicle occupant protection device recited in claim 10, wherein said silicone coating is applied at about 25 g/m².

12. The inflatable vehicle occupant protection device recited in claim 1, wherein said second coating comprises multi-layered polyurethane coating.

13. The inflatable vehicle occupant protection device recited in claim 12, wherein said multi-layered polyurethane coating is applied at about 30 g/m².

14. The inflatable vehicle occupant protection device recited in claim 12, wherein said multi-layered polyurethane coating comprises:
a base layer comprising a polycarbonate polyurethane; and
a top layer comprising a polyether polyurethane.

15. The inflatable vehicle occupant protection device recited in claim 14, wherein said base layer is applied at about 18 g/m² and said top layer is applied at about 12 g/m².

16. The inflatable vehicle occupant protection device recited in claim 14, wherein said base layer is applied at about 38 g/m² and said top layer is applied at about 12 g/m².

17. The inflatable vehicle occupant protection device recited in claim 1, wherein said second coating comprises a single layer polyurethane coating.

18. The inflatable vehicle occupant protection device recited in claim 17, wherein said second coating comprises a single layer polyether polyurethane.

19. The inflatable vehicle occupant protection device recited in claim 17, wherein said single layer polyether polyurethane coating is applied at about 30 g/m².

20. The inflatable vehicle occupant protection device recited in claim 1, wherein said second coating comprises a laminate.

21. the inflatable vehicle occupant protection device recited in claim 20, wherein said laminate is applied at about 70 g/m².

22. the inflatable vehicle occupant protection device recited in claim 21, wherein said inflatable vehicle occupant protection device comprises an inflatable curtain.

23. An apparatus for helping to protect an occupant of a vehicle having a side structure, said apparatus comprising:
an inflatable vehicle occupant protection device inflatable to a position between the side structure of the vehicle and a vehicle occupant; and
an inflation fluid source actuatable to provide inflation fluid for inflating said inflatable vehicle occupant protection device;
said inflatable vehicle occupant protection device comprising:
overlying inboard and outboard panels interconnected to define an inflatable volume;
a first coating applied to said inboard panel; and
a second coating applied to said outboard panel, said second coating being different than said first coating and having a puncture resistance greater than a puncture resistance of said first coating.

24. A one piece woven inflatable curtain comprising at least one woven single layer portion and at least one woven multilayer portion that define at least one inflatable chamber, at least one layer of said multilayer portions being woven in a non-plain weave pattern.

25. The one piece woven inflatable curtain recited in claim 24, wherein said at least one non-plain woven layer includes plain woven portions in the area adjacent said single layer portions.

26. The one piece woven inflatable curtain recited in claim 25, wherein said plain woven portions of said at least one non-plain woven layer are within five millimeters of said single layer portions.

27. The one piece woven inflatable curtain recited in claim 24, wherein said multilayer portions comprise overlying inboard and outboard panels, said inflatable curtain further comprising a first coating applied to said inboard panel and a second coating applied to said outboard panel, said second coating being different than said first coating and having a puncture resistance greater than a puncture resistance of said first coating.

28. The one piece woven inflatable curtain recited in claim 24, further comprising a coating applied to said multilayer portions.
